(19) United States
(12) Patent Application Publication
(10) Pub. No.: US 2010/0035480 A1
(43) Pub. Date: Feb. 11, 2010

(54) Cable Connector and Header

(76) Inventor: Erik Geert Henricus Egbertus Derks, Schijndel (NL)

Correspondence Address: HARRINGTON & SMITH, PC, 4 RESEARCH DRIVE, Suite 202, SHELTON, CT, 06484-6212, US

(21) Appl. No.: 12/086,198

(22) PCT Filed: Dec. 7, 2005
(86) PCT No.: PCT/EP2005/014227

§ 371 Date: Oct. 14, 2009

(51) Int. Cl. H01R 24/00; H01R 31/06

(52) U.S. Cl. 439/675; 439/628

(57) ABSTRACT

The invention relates to a cable connector including at least a first connector module and a second connector module, stacked on or above said first connector module. The first connector module includes a first insulating housing accommodating a first array of contacts (CI) and said second connector module includes a second insulating housing accommodating a second array of contacts (C2) in parallel with said first array of contacts. The first insulating housing and said second insulating housing are structurally different, in particular with respect to the polarization structure (I,II,III).

### FIELD OF THE INVENTION

Generally, the invention relates to the field of electrical connectors. More specifically, the invention relates to the field of high speed electrical connectors comprising a plurality of stacked connector modules with connector contacts.

### BACKGROUND OF THE INVENTION

In the field of telecommunications and in other electronic fields, cable connector assemblies are used to connect one electronic device to another. In many instances, the cable connector has a plurality of stacked connector modules with connector contacts, each of which serves to connect a plurality of individual wires to an opposing connector, such as a header with corresponding header contacts.

It is important that the contacts of the cable connector and the header contacts are correctly connected in accordance with the applicable connection scheme. However, in the art, the plurality connector modules are easily arranged or stacked in an incorrect manner. Consequently, an inoperative connection of a cable connector and header may be accomplished.

### SUMMARY OF THE INVENTION

It is an object of the invention to provide a cable connector and a connector header with an improved reliability of correct stacking of the connector modules and in establishing an operative connection between the cable connector and the header.

The invention provides a cable connector comprising at least a first connector module and a second connector module, stacked on said first connector module. The first connector module comprises a first insulating housing accommodating a first array of contacts and the second connector module comprises a second insulating housing accommodating a second array of contacts arranged in parallel with said first array of contacts. The first insulating housing and second insulating housing are structurally different.

The invention also provides a connector header comprising a header housing with at least a first array of header contacts and a second array of header contacts extending between a first side wall and an opposing second side wall of said header housing. The first and second side wall respectively have a first and second surface each facing said first and second array of header contacts. The first surface is structurally different from said second surface.

By providing different structures for the connector modules and/or the inner walls of the header housing, a cable connector comprising modules according to the invention and a connector header according to the invention may only connect if the structures of the connector modules correspond with the structures of the header housing walls. By providing different structures for the first and second connector module housing respectively the first and second side wall, chances are reduced that the cable connector and the connector header are incorrectly connected.

The embodiment of the invention as defined in claims 3 and 12 provides the advantage that chances are reduced that the connector modules be connected to the incorrect array of header contacts and that the orientation of the connector module in a particular array of header contacts is dictated by the polarization structures.

It should be appreciated that the cable connector may comprise further connector modules and that these connector modules may comprise further polarization structures that are structurally different from one or more of the polarization structures of the first and second connector module.

It should further be appreciated that structurally different polarization structures may relate to both a different shape for the polarization structures and/or to a different position of the polarization structures on the housings/walls.

The embodiment of the invention as defined in claims 6 and 13 provides the advantage of decreased cross-talk between adjacent leads or contacts. This phenomenon has been described in U.S. Pat. No. 6,652,318 which is incorporated by reference in the present application. Since the first housing and second housing of the connector modules are structurally different housings, staggering of the contacts can be easily implemented in the cable connector according to the invention. Thus, the structural difference of the first and second housing not necessarily relates to providing different polarization structures for the housings.

The embodiment of the invention as defined in claims 7 and 8 provides for a suitable coupling element to maintain the stack of connector modules.

The invention will be further illustrated with reference to the attached drawings, which schematically show preferred embodiments according to the invention. It will be understood that the invention is not in any way restricted to these specific and preferred embodiments.

### BRIEF DESCRIPTION OF THE DRAWINGS

In the drawings:

FIGS. 1A-1D are schematic illustrations of cable connectors with structurally different first and second cable connector modules according to an embodiment of the invention;

FIGS. 2A and 2B are front views of a cable connector and a detail of the cable connector according to the embodiment of FIG. 1D;

FIGS. 3A-3D illustrate the cable connector housings and cable termination blocks of the first and second connector modules according to an embodiment of the invention;

FIGS. 4A and 4B depict a coupling element for coupling of the cable termination blocks of FIGS. 3A-3D;

FIGS. 5A and 5B depict a cable connector from two different perspectives consisting of the first and second connector modules of FIGS. 3A-3D, and

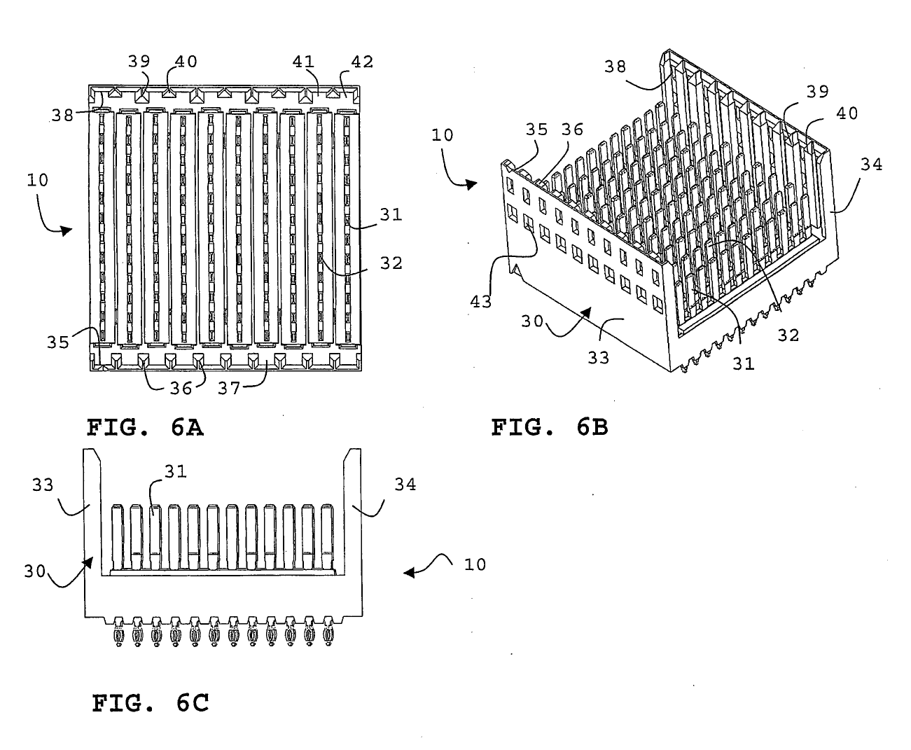

FIGS. GA-6C show a connector header according to an embodiment of the invention capable of forming a connector system with the cable connector of FIGS. 5A and 5B.

### DETAILED DESCRIPTION OF THE DRAWINGS

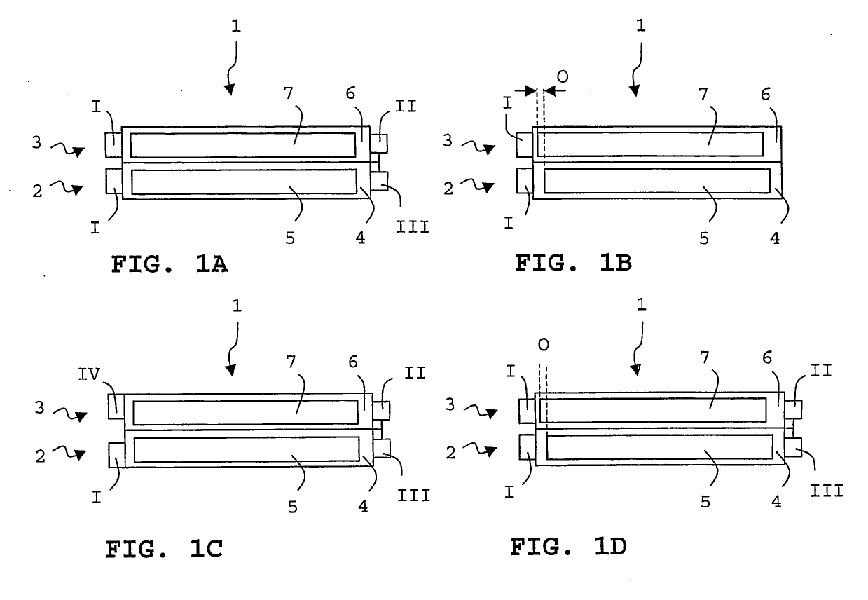

FIGS. 1A-1D are schematic illustrations of cable connectors 1 comprising a first connector module 2 and a second connector module 3, hereinafter also referred to as modules 2,3, stacked on each other. It should be noted that the first and second connector modules 2,3 not necessarily abut. There may be one or more layers or components in between, i.e. the second connector module 3 is stacked above the first connector module 2. The first module 2 comprises a first insulating housing 4 accommodating a first array 5 of contacts (not shown in FIGS. 1A-1D). The second module 3 comprises a second insulating housing 6 accommodating a second array 7 of contacts (not shown in FIGS. 1A-1D) in parallel with said first array 5 of contacts.

The first housing 4 and second housing 6 are structurally different.

In FIG. 1A, the first housing 4 has a first polarization structure I and a third polarization structure III. The second housing 6 has a first polarization structure I and a second polarization structure II. The first polarization structures I of the first housing 4 and the second housing 6 are identical. The first housing 4 and second housing 6 are structurally different by the structurally different second and third polarization structures II, III. In this embodiment, the structural difference of the polarization structures II and III resides in their different location on the housing 4,6, while they are identical in shape. It should be noted that the first and second housings are enantiomorphous, i.e. they are mirror images of each other but are not identical.

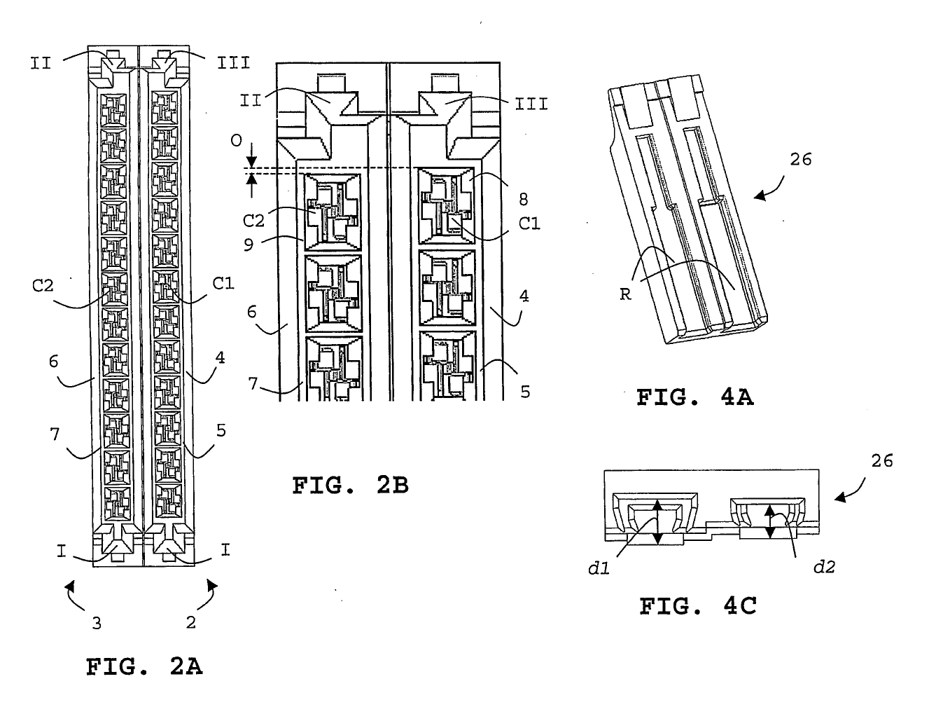

In contrast to the cable connector of FIG. 1A, the first housing 4 and second housing 6 of the cable connector 1, schematically illustrated in FIG. 1B, have identical polarization structures I. However, the first housing 4 and second housing 6 are structurally different by the staggered configuration, indicated by the offset O, of the first array 5 and second array 7 of contacts, as will be further described with reference to FIGS. 2A and 2B.

The embodiment of the cable connector 1 depicted in FIG. 1C differs from the embodiment of FIG. 1A in that the identical polarization structures I of the modules 2,3 are replaced by structurally different polarization structures I, IV. It is noted that in the embodiment of FIG. 1C, the structural difference of the polarization structures I, IV resides in the different locations on the housings 4, 6, while the polarization structures I, IV are identical in shape. Again, as in embodiment of FIG. 1A, the modules 2,3 are mirror images of each other.

Finally, the embodiment of the cable connector 1 illustrated in FIG. 1D comprises a combination of the embodiments of FIGS. 1A and 1B.

It should be appreciated that further combinations and variants of structurally different housings 4,6 fall under the scope of the present invention.

It is noted that the term ‘polarization’ refers to the requirement that a connector can be mated with a complementary connector only in a specific orientation. Similarly, the term ‘coding’ is used to indicate that only the electrical connector that should be inserted into the complementary connector will be accepted and another electrical connector, bearing a different coding, will not be able to be inserted. In this present application, the polarization structures may also be referred to as coding structures.

It should further be appreciated that structurally different polarization structures may relate to both a different shape for the polarization structures and/or to a different position of the polarization structures on the housings/walls.

The cable connector 1 schematically illustrated in FIG. 1D will next be described in further detail with reference to FIGS. 2A-6C.

In FIG. 2A a front view of the connector modules 2,3 is shown with the first array 5 having contacts C1 and the second array 7 having contacts C2. FIG. 2B shows a detail of FIG. 2A. The first housing 4 and second housing 6 have apertures 8, 9 exposing the contacts C1, C2 at the mating side of the cable connector 1. The contacts C1, C2 generally comprise both signal contacts and ground contacts.

Clearly, the first housing 4 and second housing 6 are structurally different both by the polarization structures I and III respectively I and II and by the staggered arrangement of the apertures 8, 9, indicated by the offset O. The polarization structures I, II, III allow for a correct connection of the cable connector 1 with a connector header 10, shown in detail in FIGS. 6A-6C. The staggered arrangement of the apertures 8,9 results in a staggered arrangement of the contacts C1, C2 which reduces crosstalk between the contacts if these contacts carry a signal. This phenomenon has been described in detail in U.S. Pat. No. 6,652,318 which is incorporated by reference in the present application. The offset O of the contacts is e.g. 0.1 mm.

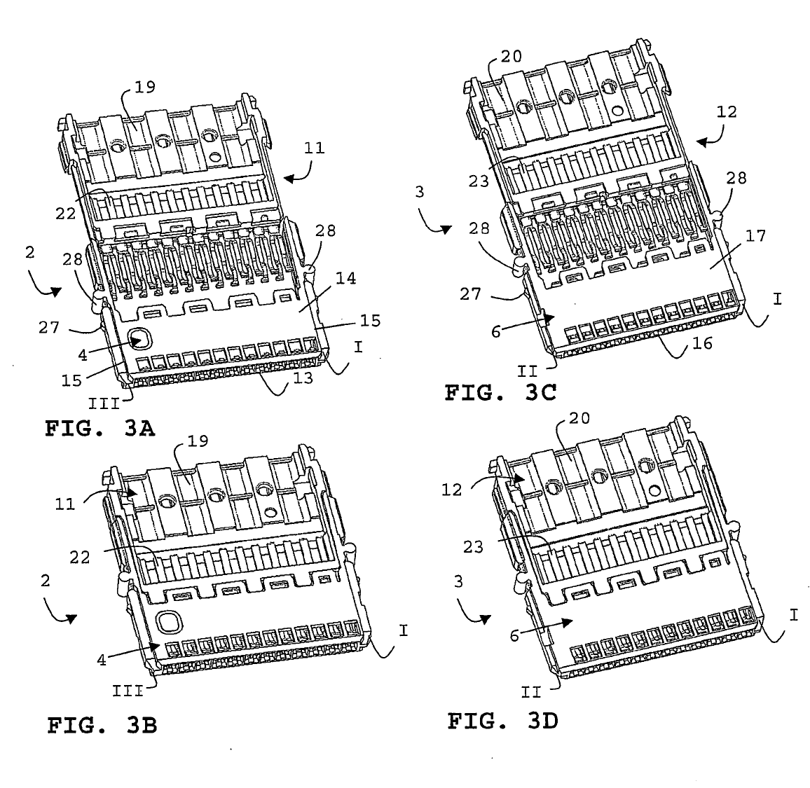

FIGS. 3A-3D illustrate the first connector module 2 (FIGS. 3A and 3B) and the second connector module 3 (FIGS. 3C and 3D) respectively. In FIGS. 3A and 3C, a first and second cable termination block 11, 12 are shown to which the contacts C1, C2 are attached. In FIGS. 3B and 3D, these cable termination blocks 11, 12 have been inserted into the first housing 4 and second housing 6 respectively.

The first housing 4 has a top wall 13 and a bottom wall 14 connected by side walls 15. The first polarization structure I and third polarization structure III are integrated with the side walls 15.

The second housing 6 has a top wall 16 and a bottom wall 17 connected by side walls 18. The first polarization structure I and second polarization structure II are integrated with the side walls 18.

The first cable termination block 11 and the second cable termination block 12 are identical. The termination blocks, sometimes referred to as inmoulded leadframe assemblies (IMLA's), have recesses 19, 20 wherein cables 21 (see FIGS. 5A and 5B) can be positioned. The exposed wires and grounds (not shown) of the cables 21 are connected to contact portions 22, 23 that are in electrical connection with the contacts C1, C2 of the first and second connector modules 2, 3. The connector modules 2,3 are completed by positioning a cable cover 24 and an overmould member 25 over the cables 21 positioned in the cable termination blocks 11, 12.

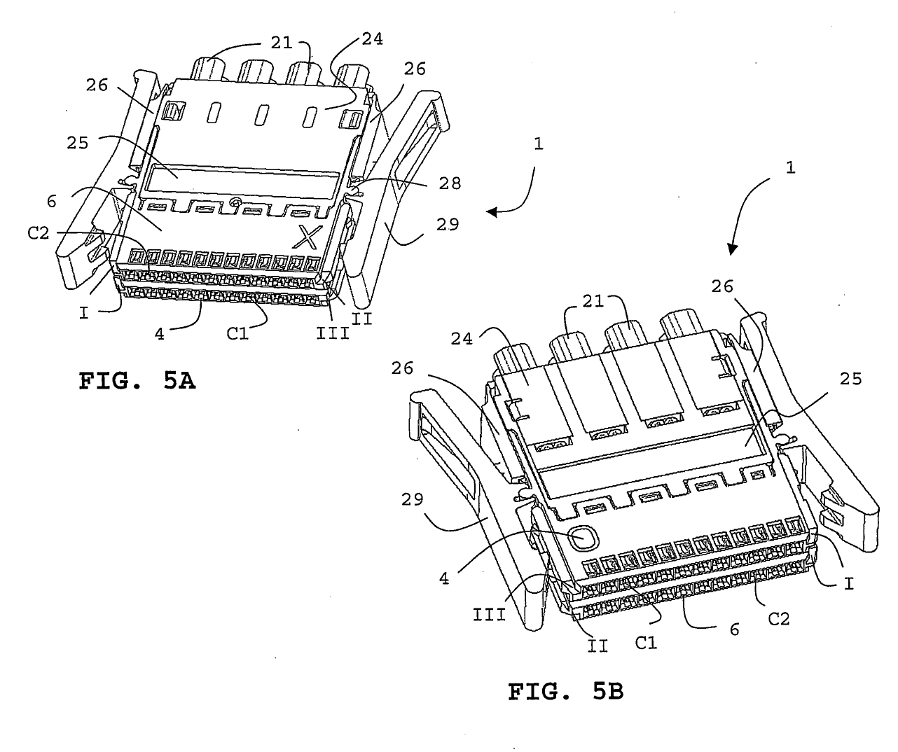

For manufacturing of the stack of connector module 2,3, the bottom wall 17 of the second connector module 3 is positioned on the top wall 13 of the first connector module 2. A coupling element 26 is applied, as shown in FIGS. 4A and 4B (cross-sectional view of coupling element 26) to connect the modules 2,3. For this purpose, the coupling element 26 comprises recesses R of different depths d1, d2 to accommodate portions of the cable termination blocks 11, 12 as illustrated in FIGS. 5A and 5B.

Finally, the first housing 4 and second housing 6 comprise a passive latching structure 27 and an attachment structure 28 capable of attaching manually operatable latches 29 to the cable connector 1 in order to firmly mount the cable connector 1 to the connector header 10, as will be described next with reference to FIGS. 6A-6C.

FIGS. 6A-6C illustrate a connector header 10 in top view, perspective view and side view respectively.

The header 10 has a header housing 30 with a first array of header contacts 31 and a second array of header contacts 32. The header contacts 31 of the first array and header contacts 32 of the second array are staggered in accordance with the offset O of the corresponding contacts C1, C2 of the cable connector 1.

The housing 30 has a first side wall 33 and an opposite second side wall 34 between which walls 33, 34 the first array 31 and second array 32 extend in a parallel fashion.

The first side wall 33 has a first surface 35 with a first series of ribs 36 extending over said surface as to constitute first header polarization structures 37 capable of receiving the first polarization structures I of the cable connector 1 described with reference to FIGS. 5A and 5B.

The second side wall 34 has a second surface 38 with a second series of ribs 39 and a third series of ribs 40, said second ribs 39 being thicker than said third ribs 40, as to constitute second header polarization structures 41 and third header polarization structures 42 capable of receiving respectively the second polarization structure II and third polarization structure III of the cable connector 1 described with reference to FIGS. 5A and 5B. As for the cable connector 1, the first, second and third header polarization structures 37, 41 and 42 are structurally different.

The side walls 33, 34 of the header 10 comprise openings 43 capable of receiving portions of the latch 29 of the cable connector 1. Clearly, the header 10 is capable of connecting a plurality of the cable connectors 1, shown in FIG. 1, in this case 5. Alternatively, a cable connector 1 may have more than two connector modules 2,3.

In operation, by interaction of the first polarization structure I with the first header polarization structure 37, the second polarization structure II with the second header polarization structure 41 and the third polarization structure III with the third header polarization structure 42, the orientation of the cable connector 1 in the header 10 is necessarily correct (i.e. no rotation of 180 degrees is possible), whereas the contacts C1 of the first connector module 2 are prevented from being connected to a second array of header contacts 32 and the contacts C2 of the second connector module 3 are prevented from being connected to a first array of header contacts 31.

1. A cable connector comprising at least a first connector module and a second connector module, stacked on or above said first connector module, said first connector module comprising a first insulating housing accommodating a first array of contacts (CI) and said second connector module comprising a second insulating housing accommodating a second array of contacts (C2) in parallel with said first array of contacts, wherein said first insulating housing and said second insulating housing are structurally different.

2. The cable connector according to claim 1, wherein said first insulating housing comprises a first polarization structure (I) and said second insulating housing comprises a second polarization structure (II), said second polarization structure being structurally different from said first polarization structure.

3. The cable connector according to claim 2, wherein said first insulating housing comprises a third polarization structure (III) structurally different from said first polarization structure (I) and said second insulating housing comprises a first polarization structure (I) structurally identical to said first polarization structure (I) of said first insulating housing.

4. The cable connector according to claim 2, wherein said first insulating housing comprises a third polarization structure (III) and said second insulating housing comprises a fourth polarization structure (IV) and wherein said third polarization structure (III) and fourth polarization structure (IV) are structurally different from each other and from said first and second polarization structures (I, II).

5. The cable connector according to claim 2, wherein said first insulating housing and second insulating housing comprise a top wall and a bottom wall connected by side walls, said top wall of said first insulating housing facing said bottom wall of said second insulating housing and wherein said polarization structures (I, II, III, IV) are attached to or integrated with said side walls.

6. The cable connector according to claim 1, wherein said first insulating housing comprises a first array of apertures and said second insulating housing comprises a second array of apertures, said first array of apertures and second array of apertures being arranged for exposing said first and second array of contacts (CI, C2) on a mating side of said cable connector and wherein said first array of apertures and said second array of apertures are staggered (0) with respect to each other in a direction of said first and second array of apertures.

7. The cable connector according to claim 1, wherein said first and second connector modules further respectively comprise a first cable termination block and a second cable termination block for terminating cables, said cable termination blocks comprising said first and second array of contacts (CI, C2) and being insertable in respectively said first and second housing and wherein said first and second cable termination blocks are coupled by means of a coupling element.

8. The cable connector according to claim 7, wherein said coupling element comprises slots (R) of different depths (dI,d2) capable of receiving sidewalls of said first and second cable termination blocks.

9. A cable connector comprising at least a first connector module and a second connector module, stacked on or above said first connector module, said first connector module comprising a first insulating housing accommodating a first array of contacts (CI) and said second connector module comprising a second insulating housing accommodating a second array of contacts (C2) in parallel with said first array of contacts, wherein said first insulating housing comprises a first polarization structure (I) and a third polarization structure (III) and said second insulating housing comprises a second polarization structure (II) and wherein said first, second and third polarization structures are structurally different.

10. A cable connector comprising at least a first connector module and a second connector module, stacked on or above said first connector module, said first connector module comprising a first insulating housing with a first array of apertures providing access to a first array of contacts (CI) and said second connector module comprising a second insulating housing with a second array of apertures providing access to a second array of contacts (C2) in parallel with said first array of contacts, wherein said first insulating housing comprises a first polarization structure (I) and a third polarization structure (III) and said second insulating housing comprises a first polarization structure (I) and a second polarization structure (II), wherein said first, second and third polarization structures are structurally different and wherein said first array of apertures and said second array of apertures are staggered (0) with respect to each other in a direction of said first and second array of apertures.

11. A connector header comprising a header housing with at least a first array of header contacts and a second array of header contacts extending between a first side wall and an opposite second side wall of said header housing, wherein said first and second side wall respectively have a first and second surface each facing said first and second array of header contacts and wherein said first surface is structurally different from said second surface.

12. The connector header according to claim 11, wherein said first surface comprises a first header polarization structure arranged to cooperate with a first polarization structure (I) of a first connector module contacting said first array of header contacts and said second surface comprises a second header polarization structure and a third header polarization structure arranged to cooperate with respectively a second polarization structure (II), structurally different from said first polarization structure, of a first connector module contacting said first array of header contacts and a third polarization structure (III), structurally different from said first and second polarization structures, of a second connector module contacting said second array of header contacts.

13. The connector header according to claim 11, wherein said first array of header contacts and said second array of header contacts are staggered with respect to each other in a direction of said arrays of header contacts.

14. A connector header comprising a header housing with at least a first array of header contacts and a second array of header contacts extending between a first side wall and an opposite second side wall of said header housing, wherein said first and second side wall respectively have a first and a second surface each facing said first and second array of header contacts and wherein said first surface comprises a first header polarization structure arranged to cooperate with a first polarization structure of a first connector module contacting said first array of header contacts and a first polarization structure (I) of a second connector module contacting said second array of header contacts and said second surface comprises a second header polarization structure and a third header polarization structure arranged to cooperate with respectively a second polarization structure (II), structurally different from said first polarization structure, of a first connector module contacting said first array of header contacts and a third polarization structure (III), structurally different from said first and second polarization structures, of a second connector module contacting said second array of header contacts.
